(19) United States
(12) Patent Application Publication
(10) Pub. No.: US 2022/0162797 A1
(43) Pub. Date: May 26, 2022

(54) MOISTURE-SENSED DEFORMING FABRIC AND MOISTURE-PROOF AND HEAT-INSULATING FABRIC

(71) Applicant: TAIWAN TEXTILE RESEARCH INSTITUTE, NEW TAIPEI CITY (TW)

(72) Inventors: Chia-Yi LIN, NEW TAIPEI CITY (TW); Sun-Wen JUAN, NEW TAIPEI CITY (TW); Jung-Yu TSAI, NEW TAIPEI CITY (TW); Chun-Hung LIN, NEW TAIPEI CITY (TW)

(21) Appl. No.: 17/347,674

(22) Filed: Jun. 15, 2021

(30) Foreign Application Priority Data
Nov. 23, 2020 (TW) 109141019
Nov. 23, 2020 (TW) 109141020

(51) Int. Cl. D06N 3/14; D06P 5/30; D06P 1/52; C09D 11/30; C09D 11/102

(52) U.S. Cl. CPC D06N 3/14; D06P 5/30; D06P 1/5285; C09D 11/30; D06N 2209/141; D06N 2209/128; D06N 2209/1657; D06N 2209/142; C09D 11/102

(57) ABSTRACT

The present disclosure provides a moisture-sensed deforming fabric which includes a base cloth and a moisture-sensed shrinking ink. The moisture-sensed shrinking ink is jetted on one of surfaces of the base cloth by a digital printing process, and the moisture-sensed shrinking ink forms a hydrophilic region on the surface of the base cloth.

### RELATED APPLICATION

This application claims priority to Taiwan Application Serial Number 109141019, filed Nov. 23, 2020, and Taiwan Application Serial Number 109141020, filed Nov. 23, 2020, which are herein incorporated by reference.

### BACKGROUND

### Field of Disclosure

The present disclosure relates to a moisture-sensed deforming fabric and a moisture-proof and heat-insulating fabric, and particularly relates to a moisture-sensed deforming fabric and a moisture-proof and heat-insulating fabric fabricated by a digital printing process.

### Description of Related Art

With the improvement of the living standards of today's society, people's demand for functional textiles has increased, and with the continuous advent of various functional textiles, the functional textiles with specific purposes have become well developed.

For wearable textiles, it often adheres to the user's skin as the user's sweat or environmental humidity increases, resulting in a significant reduction in wearing comfort. Hence, how to reduce the adhesion between the wearable textile and the user's body and thereby improving the wearing comfort is an important issue for the textile industry.

### SUMMARY

The present disclosure provides moisture-sensed deforming fabric which can partially deform after absorbing moisture to facilitate the volatilization of sweat and reduce the stickiness of the user's body, thereby providing the user with wearing comfort. The present disclosure also provides a moisture-proof and heat-insulating fabric which can not only partially deform after absorbing moisture, but also provide a good moisture one-way transport capability, so as to facilitate the volatilization of sweat, reduce the stickiness of the user's body, and provide a good heat-insulating property, thereby providing the user with wearing comfort.

According to some embodiments of the present disclosure, a moisture-sensed deforming fabric includes a base cloth and a moisture-sensed shrinking ink. The moisture-sensed shrinking ink is jetted on one of surfaces of the base cloth by a digital printing process, and the moisture-sensed shrinking ink forms a hydrophilic region on the surface of the base cloth.

In some embodiments of the present disclosure, a viscosity of the moisture-sensed shrinking ink is between 2.5 cP and 10.0 cP, a surface tension of the moisture-sensed shrinking ink is between 22 dyne/cm and 32 dyne/cm, and the moisture-sensed shrinking ink includes15 parts by weight to 35 parts by weight of a moisture-sensed shrinking resin and 65 parts by weight to 85 parts by weight of water.

In some embodiments of the present disclosure, the moisture-sensed shrinking resin is manufactured by the following reagents including a polyol, a polyamine, a first cross-linking agent, and a second cross-linking agent. Each of the first cross-linking agent and the second cross-linking agent includes an isocyanate block.

In some embodiments of the present disclosure, the hydrophilic region includes a plurality of hollow circular patterns, and the hollow circular patterns are arranged at intervals.

In some embodiments of the present disclosure, the hollow circular patterns are arranged in an array.

In some embodiments of the present disclosure, the hollow circular patterns are arranged along a first direction and a second direction, and an angle between the first direction and the second direction is between 40 degrees and 50 degrees.

In some embodiments of the present disclosure, the hydrophilic region includes a plurality of hollow hexagonal patterns, and two of the adjacent hollow hexagonal patterns share one side of each of the two adjacent hollow hexagonal patterns.

In some embodiments of the present disclosure, each of the hollow hexagon patterns is a regular hexagonal pattern.

In some embodiments of the present disclosure, the hydrophilic region includes a plurality of strip-shaped patterns, and the strip-shaped patterns are arranged in parallel.

In some embodiments of the present disclosure, the strip-shaped patterns are arranged equidistantly.

According to some embodiments of the present disclosure, a moisture-proof and heat-insulating fabric includes a base cloth, a moisture-sensed shrinking ink, and a water-repellent ink. The base cloth has a first surface and a second surface facing away from the first surface. The moisture-sensed shrinking ink is jetted on the first surface of the base cloth by a digital printing process, in which the moisture-sensed shrinking ink forms a hydrophilic region on the first surface. The water-repellent ink is jetted on the second surface of the base cloth by the digital printing process, in which the water-repellent ink forms a water-repellent region on the second surface.

In some embodiments of the present disclosure, a viscosity of the moisture-sensed shrinking ink is between 2.5 cP and 10.0 cP, a surface tension of the moisture-sensed shrinking ink is between 22 dyne/cm and 32 dyne/cm, and the moisture-sensed shrinking ink includes15 parts by weight to 35 parts by weight of a moisture-sensed shrinking resin and 65 parts by weight to 85 parts by weight of water.

In some embodiments of the present disclosure, the moisture-sensed shrinking resin is manufactured by the following reagents including a polyol, a polyamine, a first cross-linking agent, and a second cross-linking agent. Each of the first cross-linking agent and the second cross-linking agent includes an isocyanate block.

In some embodiments of the present disclosure, the first surface of the base cloth is configured to be in contact with an external environment, and the second surface of the base cloth is configured to be in contact with a body of a user.

In some embodiments of the present disclosure, the hydrophilic region includes a plurality of hollow circular patterns, and the hollow circular patterns are arranged at intervals.

In some embodiments of the present disclosure, the hollow circular patterns are arranged along a first direction and a second direction, and an angle between the first direction and the second direction is between 40 degrees and 50 degrees.

In some embodiments of the present disclosure, the hydrophilic region includes a plurality of hollow hexagonal patterns, and two adjacent hollow hexagonal patterns of the hollow hexagonal patterns share one side of each of the two adjacent hollow hexagonal patterns.

In some embodiments of the present disclosure, the hydrophilic region includes a plurality of strip-shaped patterns, and the strip-shaped patterns are arranged in parallel.

In some embodiments of the present disclosure, the water-repellent region includes a plurality of solid decagonal patterns, and two adjacent solid decagonal patterns of the solid decagonal patterns share one side or three sides of each of the two adjacent solid decagonal patterns.

In some embodiments of the present disclosure, a vertical projection of the hydrophilic region on the base cloth partially overlaps a vertical projection of the water-repellent region on the base cloth.

According to the aforementioned embodiments of the present disclosure, the moisture-sensed deforming fabric has the hydrophilic region jetted with the moisture-sensed shrinking ink. Through the configuration of the hydrophilic region, the moisture-sensed deforming fabric can partially deform after absorbing moisture to create a three-dimensional space between the moisture-sensed deforming fabric and the user's body, thereby reducing the contact between the moisture-sensed deforming fabric and the user's body. As such, the volatilization of sweat can be facilitated and the stickiness of the user's body can be reduced, thereby providing the user with wearing comfort. On the other hand, the moisture-proof and heat-insulating fabric has the hydrophilic region jetted with the moisture-sensed shrinking ink and the water-repellent region jetted with the water-repellent ink. By disposing the water-repellent region and the hydrophilic region on the two opposite surfaces of the base cloth, the moisture-proof and heat-insulating fabric can partially deform after absorbing moisture and provide a good moisture one-way transport capability, so as to facilitate the volatilization of sweat, reduce the stickiness of the user's body, and provide a good heat-insulating property, thereby providing the user with wearing comfort. In addition, by disposing the water-repellent region and the hydrophilic region on the two opposite surfaces of the base cloth, the interference between the hydrophilic region and the water-repellent region can be reduced, such that the hydrophilic region and the water-repellent region can effectively perform their respective functions.

### BRIEF DESCRIPTION OF THE DRAWINGS

The disclosure can be more fully understood by reading the following detailed description of the embodiments, with reference made to the accompanying drawings as follows:

FIG. 1 is a schematic side view illustrating a moisture-sensed deforming fabric according to some embodiments of the present disclosure;

FIGS. 2A, 2B, 2C, and 2D are schematic top views illustrating the patterns of the hydrophilic regions of the moisture-sensed deforming fabrics according to some embodiments of the present disclosure;

FIGS. 3A, 3B, 3C, and 3D are schematic side views illustrating the moisture-sensed deforming fabrics respectively having the patterns of the hydrophilic regions of FIG. 2A, 2B, 2C, and 2D after absorbing moisture;

FIG. 4 is a schematic side view illustrating a moisture-proof and heat-insulating fabric according to some embodiments of the present disclosure; and

FIG. 5 is a schematic top view illustrating the pattern of the water-repellent region of the moisture-proof and heat-insulating fabric according to some embodiments of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

In the present disclosure, the structure of a polymer or a functional group is sometimes represented by a skeleton formula. This representation can omit carbon atoms, hydrogen atoms, and carbon-hydrogen bonds. Certainly, if the atom or atom group is clearly drawn in the structural formula, the drawing shall prevail.

The present disclosure provides a moisture-sensed deforming fabric which has a hydrophilic region jetted with a moisture-sensed shrinking ink. Through the configuration of the hydrophilic region, the moisture-sensed deforming fabric can partially deform after absorbing moisture (for example, absorbing sweat) to create a three-dimensional space between the moisture-sensed deforming fabric and the user's body, thereby reducing the contact between the moisture-sensed deforming fabric and the user's body. Accordingly, the volatilization of sweat can be facilitated and the stickiness of the user's body can be reduced, thereby providing the user with wearing comfort. On the other hand, the present disclosure also provides a moisture-proof and heat-insulating fabric which has a hydrophilic region jetted with the moisture-sensed shrinking ink and a water-repellent region jetted with the water-repellent ink. By disposing the water-repellent region and the hydrophilic region on the two opposite surfaces of the base cloth, the moisture-proof and heat-insulating fabric can partially deform after absorbing moisture and provide a good moisture one-way transport capability, so as to facilitate the volatilization of sweat, reduce the stickiness of the user's body, and provide a good heat-insulating property, thereby providing the user with wearing comfort. In the following descriptions, the moisture-sensed deforming fabric and the moisture-proof and heat-insulating fabric will be described in detail sequentially.

[Moisture-Sensed Deforming Fabric]

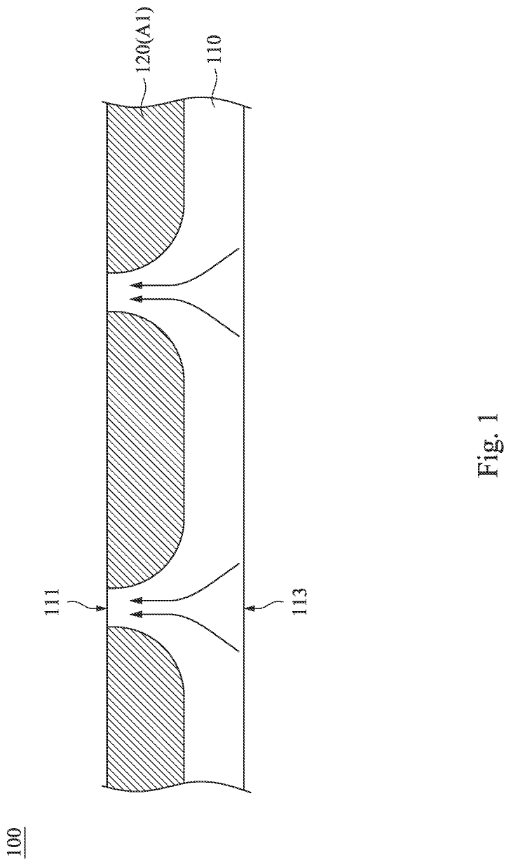

FIG. 1 is a schematic side view illustrating a moisture-sensed deforming fabric 100 according to some embodiments of the present disclosure. The moisture-sensed deforming fabric 100 includes a base cloth 110 and a moisture-sensed shrinking ink 120. The moisture-sensed shrinking ink 120 is jetted on any surface 111 of the base cloth 110 by a digital printing process, so as to form a hydrophilic region A1 on the surface 111 of the base cloth 110. In some embodiments, the base cloth 110 may be woven from, for example, elastic fibers, non-elastic fibers, or combinations thereof. For example, the base cloth 110 may be, for example, a knitted fabric or a woven fabric woven from 92% of a polyester fiber and 8% of a polyurethane fiber. In some embodiments, the moisture-sensed shrinking ink 120 can be jetted on the surface 111 of the base cloth 110 facing an external environment, and the hydrophilic region A1 formed by the moisture-sensed shrinking ink 120 may have a variety of patterns, so as to provide good moisture-sensing deformation, which will be discussed in more detail below.

Specifically, when the moisture-sensed deforming fabric 100 is worn by the user, the base cloth 110 has better hydrophobicity than the hydrophilic region A1 formed by the moisture-sensed shrinking ink 120, and the hydrophilic region A1 is formed on the surface 111 of the base cloth 110 facing the external environment. Therefore, the sweat produced by the user's body will suffer a pulling force (for example, a pulling force along a direction of an arrow shown in FIG. 1), such that the sweat is guided from the surface 113 of the base cloth 110 facing the user's body to the surface 111 of the base cloth 110 facing the external environment, thereby facilitating the volatilization, of sweat. On the other hand, the sweat guided to the surface 111 of the base cloth 110 can enter the hydrophilic region A1, resulting in the deformation of the hydrophilic region A1 due to moisture absorption, such that the moisture-sensed deforming fabric 100 is partially arched or recessed to create a three-dimensional space between the moisture-sensed deforming fabric 100 and the user's body. Accordingly, the contact between the moisture-sensed deforming fabric 100 and the user's body can be reduced, such that the volatilization of sweat can be facilitated and the stickiness of the user's body can be reduced, thereby providing the user with wearing comfort.

In some embodiments, the moisture-sensed shrinking ink 120 mainly includes 15 parts by weight to 35 parts by weight of a moisture-sensed shrinking resin and 65 parts by weight to 85 parts by weight of water. The moisture-sensed shrinking resin has a plurality of amino groups and hydroxyl groups, and can be firmly disposed on the base cloth 110, so as to improve the moisture-sensed shrinking property of the moisture-sensed shrinking ink 120 and the moisture-sensed deforming fabric 100 fabricated thereby. In some embodiments, the moisture-sensed shrinking resin may be manufactured by the following reagents, which includes a polyol, a polyamine, a first cross-linking agent, and a second cross-linking agent. In some embodiments, an additive amount of the polyol may be between 0.5 parts by weight to 1.5 parts by weight, an additive amount of the polyamine may be between 40 parts by weight to 50 parts by weight, an additive amount of the first cross-linking agent may be between 2.2 parts by weight to 2.6 parts by weight, and an additive amount of the second cross-linking agent may be between 0.4 parts by weight to 0.8 parts by weight.

In some embodiments, the polyol can provide the moisture-sensed shrinking resin with a good moisture-sensed shrinking property, such that the moisture-sensed shrinking ink 120 can be provided with a good moisture-sensed shrinking property. As such, the moisture-sensed deforming fabric 100 manufactured by the moisture-sensed shrinking ink 120 can be provided with high shrinking ratio per unit area. In some embodiments, the polyol may be, for example, an ether polyol including polyethylene glycol (PEG), polypropylene glycol (PPG), or poly(tetramethylene ether) glycol (PTMEG). In some embodiments, an average molecular weight of the polyol may be between 200 g/mole and 600 g/mole. Specifically, if the average molecular weight of the polyol is less than 200 g/mole, the moisture-sensed shrinking resin formed may not be firmly disposed on the base cloth 110, and hence the moisture-sensed deforming fabric 100 has poor moisture-sensed shrinking property and washing fastness; and if the average molecular weight of the polyol is greater than 600 g/mole, the viscosity of the moisture-sensed shrinking ink 120 may be too high, making it difficult for the moisture-sensed shrinking ink 120 to be jetted on the base cloth 110.

In some embodiments, the polyamine can provide the moisture-sensed shrinking resin with a good moisture-sensed shrinking property, such that the moisture-sensed shrinking ink 120 can be provided with a good moisture-sensed shrinking property. As such, the moisture-sensed deforming fabric 100 manufactured by the moisture-sensed shrinking ink 120 can be provided with high shrinking ratio per unit area. In some embodiments, the polyamine may include polyimide, polyamide, or polyetheramine. In some other embodiments, the polyamine may include aliphatic amine, so as to better provide the moisture-sensed shrinking resin with a good moisture-sensed shrinking property. Specifically, the aliphatic amine may be, for example, hexylenediamine, diethyl hexamethylenediamine, trimethylhexamethylenediamine, heptanediamine, trimethylethylenediamine, tetraethylethylenediamine, tetramethylethylenediamine, nonanediamine, laurylamine dipropylenediamine, diethylenetriamine, triethylenetetramine, or polyethyleneimine. In some embodiments, an average molecular weight of the polyamine may be between 600 g/mole and 8000 g/mole, and preferably between 800 g/mole and 5500 g/mole.

In some embodiments, the first cross-linking agent may include isocyanate trimer. Specifically, the first cross-linking agent may include a structural unit represented by formula (1),

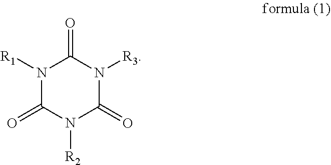

In some embodiments, the first cross-linking agent may include aliphatic isocyanate (e.g., HDI, TMDI or XDI) timer, alicyclic isocyanate (e.g., IPDI, HMDI or HTDI) trimer, aromatic isocyanate (e.g., TDI or MDI) trimer, or combinations thereof. The first cross-linking agent may include an isocyanate block. For example, at least two terminals of the isocyanate trimer may have the isocyanate blocks. Specifically, in the first cross-linking agent represented by formula (1), any two or more of R1, R2, and R3 include the isocyanate blocks.

In some embodiments, the second cross-linking agent and the first cross-linking agent may have the same molecular structure. In some embodiments, a ratio of the additive amount of the second cross-linking agent to the additive amount of the first cross-linking agent may be, for example, between 1:5 and 1:3. In some embodiments, a ratio of a total number of the isocyanate block to a total number of the hydroxyl group may be between 1.0 and 2.5.

In some embodiments, a viscosity of the moisture-sensed shrinking ink 120 may be between 2.5 cP and 10.0 cP, such that the ink droplets can be jetted with a suitable size, and the moisture-sensed shrinking ink 120 can have suitable fluidity to facilitate the digital printing process. On the other hand, a surface tension of the moisture-sensed shrinking ink 120 may be between 22 dyne/cm and 32 dyne/cm, which facilitates the formation of the ink droplets at the nozzle and provides the moisture-sensed shrinking ink 120 with good permeability. In some embodiments, a particle diameter (D90) of the dispersant in the moisture-sensed shrinking ink 120 may be between 90 nm and 360 nm, such that the problem of nozzle clogging during the digital printing process can be avoided, and the moisture-sensed shrinking ink 120 can be provided with good stability. The particle diameter (D90) of the aforementioned dispersant will also affect the viscosity of the moisture-sensed shrinking ink 120. For example, a smaller dispersant particle diameter in moisture-sensed shrinking ink 120 can provide the moisture-sensed shrinking ink 120 with a lower viscosity. In some embodiments, the moisture-sensed shrinking ink 120 may have a pH value between 6.0 and 8.5 at 25° C., so as to avoid corrosion of the nozzle of the printing device, and prevent the ink droplets from depositing at the nozzle resulting in nozzle clogging, which is advantageous for the digital printing process.

In some embodiments, the moisture-sensed shrinking ink 120 may further include 5 parts by weight to 10 parts by weight of a humectant, 0.004 parts by weight to 0.060 parts by weight of a surfactant, and/or 0.002 parts by weight to 0.020 parts by weight of a defoamer. The humectant can ensure the moisture-sensed shrinking ink 120 to be prevented from deposition or nozzle clogging due to agglomeration during the printing process. The surfactant can maintain the size of the particles (such as the moisture-sensed shrinking resin, the humectant, etc.) in the moisture-sensed shrinking ink 120. The defoamer can ensure that no foam is in the moisture-sensed shrinking ink 120. In some embodiments, the humectant may be, for example, glycerol, diethylene glycol, propylene glycol methyl ether, or combinations thereof. In some embodiments, the surfactant may be, for example, polydimethylsiloxane, polyether modified siloxane, polyether modified polydimethylsiloxane, or combinations thereof. In some embodiments, the defoamer may be, for example, polyether modified polydimethylsiloxane, foam breaking polysiloxane, a mixture of foam breaking polysiloxane and hydrophobic particles dissolved in polyethylene glycol, or combinations thereof.

In some embodiments, the moisture-sensed shrinking ink 120 may further include an appropriate amount of a dispersing agent, an appropriate amount of a PH regulator, and an appropriate amount of a bacteriostatic agent. The dispersing agent can ensure that the dispersion in the moisture-sensed shrinking ink 120 is completely dispersed, such that the generation of precipitates or agglomerates which leads to the nozzle clogging can be avoided. The PH regulator can ensure that the pH value of the moisture-sensed shrinking ink 120 is between 6.0 and 8.5, such that the influence to the solubility of the components in the moisture-sensed shrinking ink 120 caused by the moisture-sensed shrinking ink 120 being too acidic or alkaline can be prevented, and the formation of the deposits which will block the nozzle or cause the nozzle corroded can be avoided. The antibacterial agent can effectively inhibit the growth of bacteria.

In some embodiments, the moisture-sensed shrinking ink 120 may further include an appropriate amount of a colorant, such that the fabric to be jetted has an appropriate color. In some embodiments, a particle size (D90) of the colorant in the moisture-sensed shrinking ink 120 may be less than or equal to 250 nm, such that the colorant can effectively penetrate into the fabric to be jetted, thereby improving the color fastness. In some embodiments, the colorant may be, for example, a pigment or a dye, and the dye may be, for example, a dispersive dye, a high-temperature dispersive dye, a reactive dye, or an acid dye. When the moisture-sensed shrinking ink 120 includes the colorant, the moisture-sensed shrinking ink 120 can provide the fabric with partial or overall color and a moisture-sensed shrinking property through the digital printing process all at once, thereby effectively solving the problem of color fastness decline caused by dye migration during a traditional secondary processing.

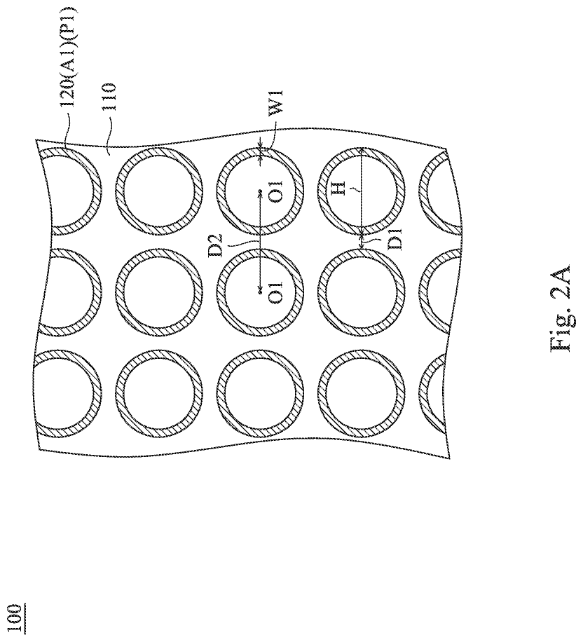

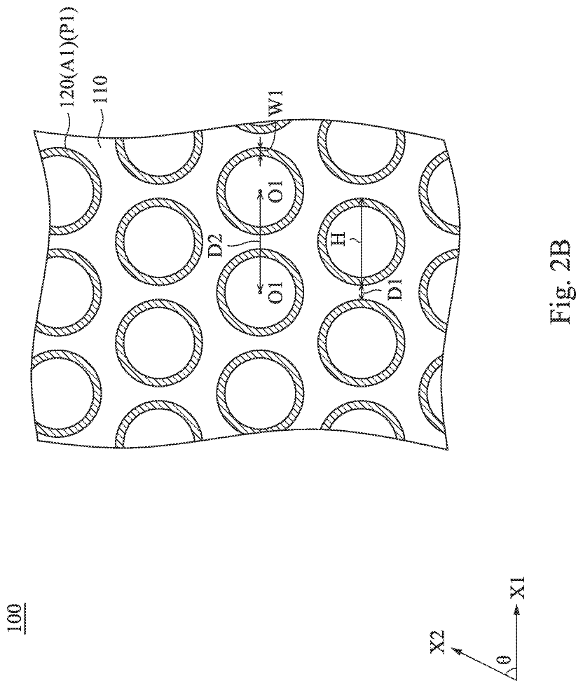

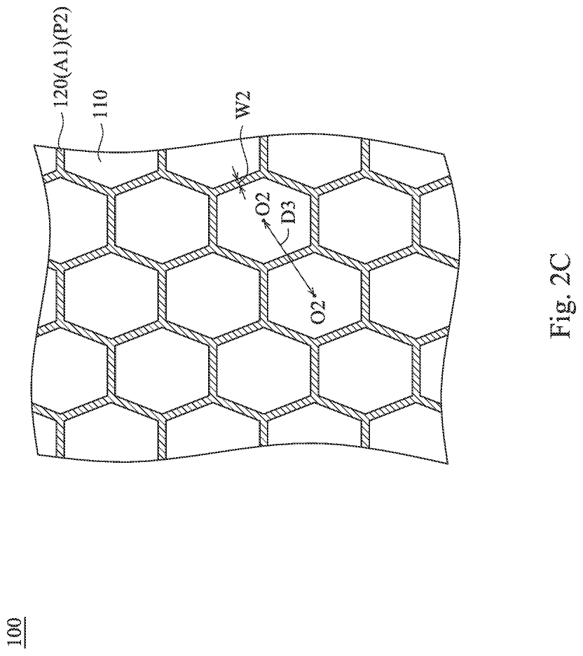

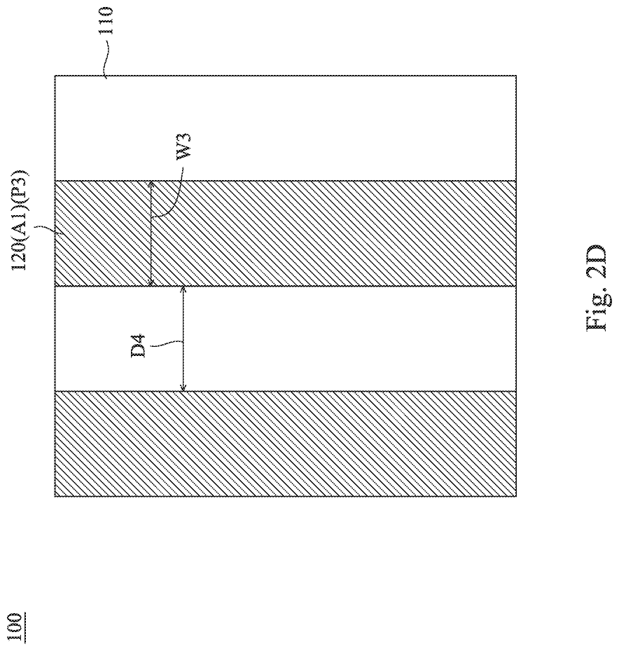

As mentioned above, the hydrophilic region A1 formed by the moisture-sensed shrinking ink 120 can have various patterns to provide a good moisture-sensed deforming property. Reference is made to FIGS. 2A, 2B, 2C, and 2D, which are schematic top views illustrating the patterns of the hydrophilic regions A1 of the moisture-sensed deforming fabrics 100 according to some embodiments of the present disclosure. In the following descriptions, the various patterns of the hydrophilic regions A1 will be described in more detail.

Firstly, reference is made to FIG. 1 and FIG. 2A. In some embodiments, the hydrophilic region A1 may include a plurality of hollow circular patterns P1. In other words, the moisture-sensed shrinking ink 120 is jetted to form a plurality of hollow circular patterns P1 on the surface 111 of the base cloth 110. In some embodiments, the hollow circular patterns P1 may be arranged at intervals to reserve space for the deformation of the moisture-sensed deforming fabric 100. In some embodiments, a shortest distance D1 between two adjacent hollow circular patterns P1 may be between 4 mm and 12 mm, and a distance D2 between the centers O1 of the two adjacent hollow circular patterns P1 may be between 10 mm and 14 mm. As such, it can be ensured that the moisture-sensed deforming fabric 100 has a certain degree of deformation, and a sufficient space is reserved for the moisture-sensed deforming fabric 100 to deform. In detail, if the shortest distance D1 between the two adjacent hollow circular patterns P1 is less than 4 mm or the distance D2 between the centers O1 of the two adjacent hollow circular patterns P1 is less than 10 mm, there may not be enough space between the two adjacent hollow circular patterns P1 for the deformation of the moisture-sensed deforming fabric 100, such that the moisture-sensed deforming fabric 100 may distorted excessively due to a high degree of deformation, thereby affecting the wearing comfort of the user; if the shortest distance D1 between two adjacent hollow circular patterns P1 is greater than 12 mm or the distance D2 between the centers O1 of the two adjacent hollow circular patterns P1 is greater than 14 mm, the distribution density of the hollow circular patterns P1 may be excessively low, resulting in a low degree of deformation of the moisture-sensed deforming fabric 100.

In some embodiments, a diameter H of the hollow circular patterns P1 may be between 5 mm and 8 mm, and a line width W of the hollow circular patterns P1 may be between 1.5 mm and 3.0 mm. The diameter H and the line width W1 of the hollow circular pattern P1 can affect the area of the hollow circular pattern P1, thereby affecting the degree of deformation of the moisture-sensed deforming fabric 100. In detail, if the diameter H of the hollow circular pattern P1 is less than 5 mm and the line width W1 of the hollow circular pattern P1 is greater than 3.0 mm, the deformation area of the moisture-sensed deforming fabric 100 may be too large, which may affect the wearing comfort of the user; if the diameter H of the hollow circular pattern P1 is greater than 8 mm and the line width W1 of the hollow circular pattern P1 is less than 1.5 mm, the deformation area of the moisture-sensed deforming fabric 100 may be too small, resulting in a low degree of deformation of the moisture-sensed deforming fabric 100. In some embodiments, the hollow circular patterns P1 may further be arranged in an array, so as to improve the uniformity of deformation of the moisture-sensed deforming fabric 100.

Next, reference is made to FIG. 1 and FIG. 2B. In some embodiments, the hollow circular patterns P1 may be arranged, for example, in a staggered manner. Specifically, the hollow circular patterns P1 may be arranged along a first direction X1 and a second direction X2, and an angle θ between the first direction X1 and the second direction X2 is between 40 degrees and 50 degrees. In some embodiments, the hollow circular patterns P1 may be arranged equidistantly along the first direction X1 and the second direction X2. Based on the above configuration, the hollow circular patterns P1 can be distributed on the surface 111 of the base cloth 110 with an appropriate density to ensure that the moisture-sensed deforming fabric 100 has a certain degree of deformation after absorbing moisture. It should be understood that the shortest distance D1 between the two adjacent hollow circular patterns P1, the distance D2 between the centers O1 of the two adjacent hollow circular patterns P1, and the diameter H and the line width W1 of the hollow circular patterns P1 can refer to the embodiment shown in FIG. 2A, which will not be repeated hereinafter.

Then, reference is made to FIG. 1 and FIG. 2C. In some embodiments, the hydrophilic region A1 may include a plurality of hollow hexagonal patterns P2, and two adjacent hollow hexagonal patterns P2 share one side of each of the two adjacent hollow hexagonal patterns P2. In other words, the hollow hexagonal patterns P2 form a honeycomb-like pattern on the surface 111 of the base cloth 110. In some embodiments, a distance D3 between the centers O2 of the two adjacent hollow hexagonal patterns P2 may be between 8 mm and 16 mm. As such, it can be ensured that the moisture-sensed deforming fabric 100 has a certain degree of deformation, and a sufficient space is reserved for the moisture-sensed deforming fabric 100 to deform. In some embodiments, a line width W2 of the hollow hexagonal pattern P2 may be between 1.5 mm and 3.0 mm. In detail, if the line width W2 of the hollow hexagonal pattern P2 is greater than 3.0 mm, the deformation area of the moisture-sensed deforming fabric 100 may be too large, which will affect the wearing comfort of the user; if the line width W2 of the hollow hexagonal pattern P2 is less than 1.5 mm, the deformation area of the moisture-sensed deforming fabric 100 may be too small, resulting in a low degree of deformation of the moisture-sensed deforming fabric 100. In some embodiments, a length of each side of the hollow hexagonal pattern P2 is equal, that is, the hollow hexagonal pattern P2 is a hollow regular hexagon, so as to improve the uniformity of deformation of the moisture-sensed deforming fabric 100.

Finally, reference is made to FIG. 1 and FIG. 2D. In some embodiments, the hydrophilic region A1 may include a plurality of strip-shaped patterns P3, and the strip-shaped patterns P3 are arranged in parallel and at intervals. In some embodiments, a line width W3 of the strip-shaped pattern P3 may be between 5 mm and 20 mm, and a shortest distance D4 between two adjacent strip-shaped patterns P3 may be between 5 mm and 20 mm. Within the above range, the moisture-sensed deforming fabric 100 can have a certain degree of deformation and a high uniformity of deformation. In some embodiments, the line width W3 of the strip-shaped pattern P3 may be substantially near or identical to the shortest distance D4 between the two adjacent strip-shaped patterns P3, and the strip-shaped patterns P3 may be arranged equidistantly, thereby providing better uniformity of deformation of the moisture-sensed deforming fabric 100.

In the following descriptions, various tests and evaluations will be performed on the moisture-sensed deforming fabrics according to various embodiments of the present disclosure to further verify the efficacy of the present disclosure.

<Experiment 1: Moisture-Sensed Shrinking Evaluation on Moisture-Sensed Deforming Fabrics>

In this experiment, the moisture-sensed shrinking ink is jetted on the surface of the base cloth by the digital printing process to form the moisture-sensed deforming fabric with a pattern of the hydrophilic region. Then, the moisture-sensed deforming fabric is soaked in water, and an average concave/convex depth of the moisture-sensed deforming fabric after deformation is measured and calculated. In the moisture-sensed deforming fabric of each embodiment, the base cloth is a knitted fabric woven from 92% of the polyester (PET) fiber and 8% of the polyurethane (OP) fiber, and the weight of the base cloth is 180 gsm. Other detailed information and measurement results of the moisture-sensed deforming fabric of each embodiment are shown in Table 1.

TABLE 1

| | | distance between | | | |
|---|---|---|---|---|---|
| | pattern of | centers of | diameter | line | average |
| | hydrophilic | two adjacent | of pattern | width | concave/convex |
| | region | patterns (mm) | (mm) | (mm) | depth (mm) |
| Embodiment 1 | hollow | 10 | 7 | 3.0 | 1.10 |
| Embodiment 2 | circular | 10 | 6 | 2.0 | 0.93 |
| Embodiment 3 | pattern | 10 | 5 | 1.5 | 0.74 |
| Embodiment 4 | (as shown | 12 | 8 | 3.0 | 1.33 |
| Embodiment 5 | in FIG. 2A) | 14 | 8 | 3.0 | 1.34 |
| Embodiment 6 | | 10 | 8 | 2.5 | 1.11 |
| Embodiment 7 | | 10 | 8 | 2.0 | 0.95 |
| Embodiment 8 | | 10 | 8 | 1.5 | 0.75 |
| Embodiment 9 | hollow | 10 | 7 | 3.0 | 0.97 |
| Embodiment 10 | circular | 10 | 6 | 2.0 | 0.83 |
| Embodiment 11 | pattern | 10 | 5 | 1.5 | 0.72 |
| Embodiment 12 | (as shown | 12 | 8 | 3.0 | 1.05 |
| Embodiment 13 | in FIG. 2B) | 14 | 8 | 3.0 | 1.05 |
| Embodiment 14 | | 10 | 8 | 2.5 | 1.18 |
| Embodiment 15 | | 10 | 8 | 2.0 | 1.08 |
| Embodiment 16 | | 10 | 8 | 1.5 | 1.34 |
| | | distance between | | | |
| | pattern of | centers of | line | average | |
| | hydrophilic | two adjacent | width | concave/convex | |
| | region | patterns (mm) | (mm) | depth (mm) | |
| Embodiment 17 | hollow | 10 | 3.0 | 0.37 | |
| Embodiment 18 | hexagonal | 12 | 3.0 | 0.71 | |
| Embodiment 19 | pattern | 14 | 3.0 | 1.10 | |
| Embodiment 20 | (as shown | 16 | 3.0 | 1.08 | |
| Embodiment 21 | in FIG. 2C) | 8 | 2.0 | 0.41 | |
| Embodiment 22 | | 8 | 1.5 | 0.39 | |
| Embodiment 23 | strip-shaped | 5 | 5 | 1.18 | |
| Embodiment 24 | pattern | 10 | 10 | 3.29 | |
| Embodiment 25 | (as shown | 15 | 15 | 3.68 | |
| Embodiment 26 | in FIG. 2D) | 20 | 20 | 2.12 | |
| Embodiment 27 | | 5 | 15 | 2.49 | |
| Embodiment 28 | | 10 | 15 | 3.86 | |
| Embodiment 29 | | 20 | 15 | 2.29 | |
| Embodiment 30 | | 5 | 10 | 2.56 | |
| Embodiment 31 | | 15 | 10 | 4.26 | |
| Embodiment 32 | | 20 | 10 | 4.11 | |

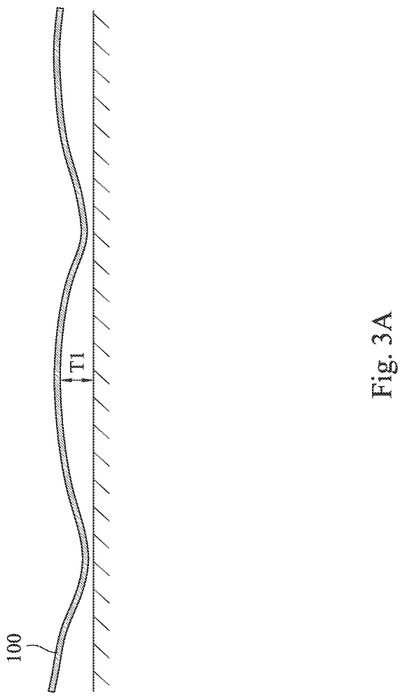

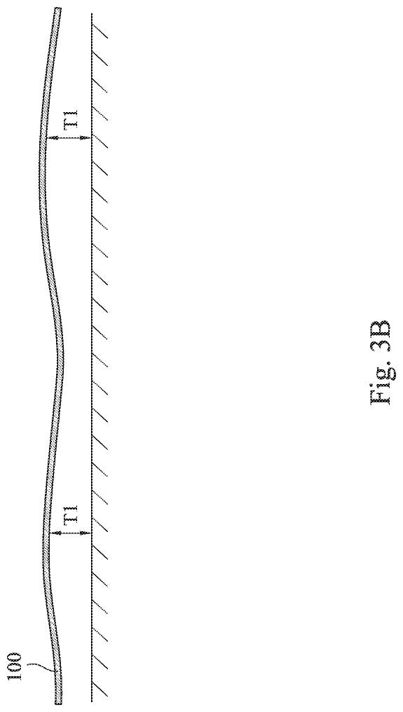

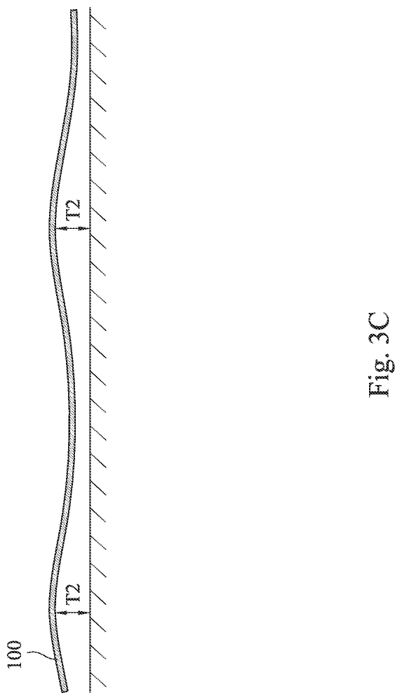

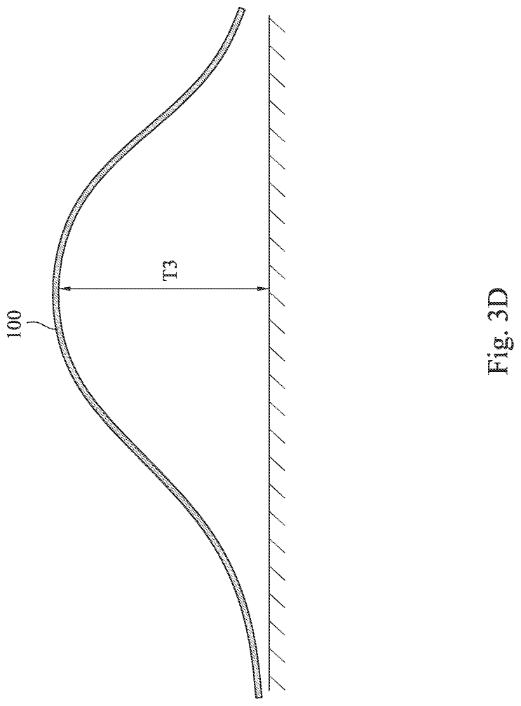

FIGS. 3A, 3B, 3C, and 3D are schematic side views illustrating the moisture-sensed deforming fabrics respectively having the patterns of the hydrophilic regions of FIG. 2A, 2B, 2C, and 2D after absorbing moisture. It can be seen from Table 1 that the average concave/convex depth of the moisture-sensed deforming fabric of each embodiment after absorbing moisture can be between 0.37 mm and 4.26 mm, in which the patterns of the hydrophilic regions of the moisture-sensed deforming fabrics of Embodiments 1 to 16 are hollow circular patterns, and their average concave/convex depths T1 are between 0.72 mm and 1.34 mm (as shown in FIG. 3A and FIG. 3B); the patterns of the hydrophilic regions of the moisture-sensed deforming fabrics of Embodiments 17 to 22 are hollow hexagonal patterns, and their average concave/convex depths T2 are between 0.37 mm and 1.10 mm (as shown in FIG. 3C); the patterns of the hydrophilic regions of the moisture-sensed deforming fabrics of Embodiments 23 to 32 are strip-shaped patterns, and their average concave/convex depths T3 are between 1.18 mm and 4.26 mm (as shown in FIG. 3D). The results indicate that the moisture-sensed deforming fabric of each embodiment has a certain degree of deformation after absorbing moisture, thereby providing a good moisture-sensed shrinking property. Overall, when the pattern of the hydrophilic region is a strip-shaped pattern, the moisture-sensed deforming fabric provides a better moisture-sensed shrinking property.

<Experiment 2: Moisture-Sensed Shrinking Evaluation on Moisture-Sensed Deforming Fabrics of Different Fabric Specifications>

In this experiment, the moisture-sensed shrinking ink is jetted on the surface of the base cloth of different specifications by the digital printing process to form the moisture-sensed deforming fabric with a pattern of the hydrophilic region. Then, the moisture-sensed deforming fabric is soaked in water, and an average concave/convex depth of the moisture-sensed deforming fabric after deformation is measured and calculated. The detailed information and measurement results of the moisture-sensed deforming fabric of each embodiment are shown in Table 2.

TABLE 2

| | average concave/convex depth (mm) | | | | |
|---|---|---|---|---|---|
| | | 92% PET + | 92% PET + | 92% PET + | |
| | 100% PET | 8% OP | 8% OP | 8% OP | 100% PET |
| | single jersey | single jersey | single jersey | single jersey | interlock |
| | knitted fabric | knitted fabric | knitted fabric | knitted fabric | knitted fabric |
| | 230 gsm | 180 gsm | 292 gsm | 250 gsm | 230 gsm |
| Embodiment 33 | 2.32 | 1.33 | 1.65 | 1.63 | 0.65 |
| Embodiment 34 | 1.90 | 1.34 | 1.29 | 2.01 | 0.76 |
| Embodiment 35 | 2.11 | 1.11 | 0.86 | 1.23 | 0.49 |
| Embodiment 36 | 1.45 | 1.05 | 0.87 | 1.39 | 0.54 |
| Embodiment 37 | 1.86 | 1.34 | 0.47 | 0.69 | 0.34 |
| Embodiment 38 | 5.65 | 3.68 | 3.88 | 1.34 | 1.13 |
| Embodiment 39 | 4.45 | 3.86 | 5.09 | 0.99 | 1.09 |
| Embodiment 40 | 3.94 | 4.26 | 3.43 | 1.46 | 1.19 |
| Embodiment 41 | 2.46 | 4.11 | 3.44 | 1.43 | 3.02 |

Note:
Embodiments 33, 34, 35, 36, 37, 38, 39, 40, and 41 respectively have the hydrophilic patterns of Embodiments 4, 5, 6, 12, 16, 25, 28, 31, and 32.

It can be seen from Table 2 that the average concave/convex depths of the moisture-sensed deforming fabrics of Embodiments 33 to 41 after absorbing moisture can be between 0.34 mm and 5.65 mm, showing a certain degree of deformation. In other words, the moisture-sensed shrinking ink of the present disclosure can be jetted on the base cloths of different specifications by the digital printing process, and the formed moisture-sensed deforming fabrics can all provide a good moisture-sensed shrinking property.

<Experiment 3: Stickiness Evaluation on Moisture-Sensed Deforming Fabrics>

In this experiment, the fabric of Comparative Example 1 and the moisture-sensed deforming fabrics of the embodiments in Table 1 are tested for tensile viscosity force, in which the fabric of Comparative Example 1 is a knitted fabric woven from 92% of the polyester fiber and 8% of the polyurethane fiber. The test method is to soak the fabric of the comparative example and the moisture-sensed deforming fabric of each embodiment in water, and place the fabric of the comparative example and the moisture-sensed deforming fabric of each embodiment on an artificial skin, and then stretch the fabric of the comparative example and the moisture-sensed deforming fabric of each embodiment, in which a stretching direction is parallel to a rib direction of the fabric. The test results are shown in Table 3.

TABLE 3

| | tensile viscosity |
|---|---|
| | force (gf) |
| Comparative | 480 |
| Example 1 | |
| Embodiment 3 | 150 |
| Embodiment 5 | 170 |
| Embodiment 11 | 190 |
| Embodiment 16 | 250 |
| Embodiment 17 | 150 |
| Embodiment 19 | 130 |
| Embodiment 23 | 90 |
| Embodiment 31 | 150 |

It can be seen from Table 3 that, compared with the fabric of the comparative example, the moisture-sensed deforming fabric of each embodiment can be separated from the artificial skin through a smaller tensile viscosity force. In other words, the moisture-sensed deforming fabric of each embodiment is less likely to stick to the user's body after moisture-sensing deformation, so as to facilitate the volatilization of sweat and reduce the stickiness of the user's body, thereby providing the user with wearing comfort.

According to the aforementioned embodiments of the present disclosure, the moisture-sensed deforming fabric has the hydrophilic region jetted with the moisture-sensed shrinking ink. Through the configuration of the hydrophilic region, the moisture-sensed deforming fabric can partially deform after absorbing moisture to create a three-dimensional space between the moisture-sensed deforming fabric and the user's body, thereby reducing the contact between the moisture-sensed deforming fabric and the user's body. As such, the volatilization of sweat can be facilitated and the stickiness of the user's body can be reduced, thereby providing the user with wearing comfort. On the other hand, through the design of the pattern of the hydrophilic region, the moisture-sensed shrinking property of the moisture-sensed deforming fabric can further be improved.

[Moisture-Proof and Heat-Insulating Fabric]

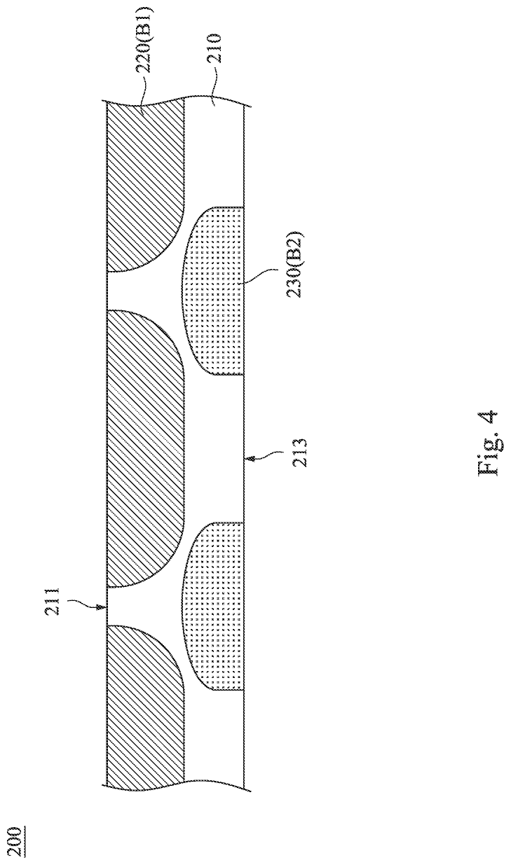

FIG. 4 is a schematic side view illustrating a moisture-proof and heat-insulating fabric 200 according to some embodiments of the present disclosure. The moisture-proof and heat-insulating fabric 200 of the present disclosure includes a base cloth 210, a moisture-sensed shrinking ink 220, and a water-repellent ink 230. The base cloth 210 has a first surface 211 and a second surface 213 facing away from the first surface 211. In some embodiments, the first surface 211 may be a surface in contact with an external environment, and the second surface 213 may be a surface in contact with a body of a user. In some embodiments, the base cloth 210 may be woven from, for example, elastic fibers, non-elastic fibers, or combinations thereof. For example, the base cloth 210 may be, for example, a knitted fabric or a woven fabric woven from 92% of a polyester fiber and 8% of a polyurethane fiber. The moisture-sensed shrinking ink 220 is jetted on the first surface 211 of the base cloth 210 by a digital printing process to form a hydrophilic region B1 on the first surface 211 of the base cloth 210, and the water-repellent ink 230 is jetted on the second surface 213 of the base cloth 210 to form a water-repellent region B2 on the second surface 213 of the base cloth 210. With the configuration of the hydrophilic region B1 and the water-repellent region B2 and their respective pattern designs, the moisture-proof and heat-insulating fabric 200 of the present disclosure can provide a good moisture-sensed deforming property, a good moisture one-way transport capability, and a good heat-insulating property, thereby providing the user with wearing comfort, which will be discussed in more detail below.

Specifically, when the moisture-proof and heat-insulating fabric 200 is worn by the user, the second surface 213 of the base cloth 210 in contact with the user's body has the water-repellent region B2, and the first surface 211 of the base cloth 210 in contact with the external environment has the hydrophilic region B1. Therefore, the sweat produced by the user's body will suffer a pulling force, such that the sweat is guided from the second surface 213 of the base cloth 210 to the first surface 211 of the base cloth 210, thereby providing a moisture one-way transport capability and facilitating the volatilization of sweat. In some embodiments, the hydrophilicity of the base cloth 210 may be lower than the hydrophilicity of the hydrophilic region B1 and be higher than the water-repellent region B2, so as to better improve the moisture one-way transport capability. With the moisture one-way transport capability of the moisture-proof and heat-insulating fabric 200, the reverse flow of sweat can be prevented, so as to provide a good heat-insulating property. On the other hand, the sweat guided to the first surface 211 of the base cloth 210 can enter the hydrophilic region B1, resulting in the deformation of the hydrophilic region B1 due to moisture absorption, such that the moisture-proof and heat-insulating fabric 200 is partially arched or recessed to create a three-dimensional space between the moisture-proof and heat-insulating fabric 200 and the user's body. Accordingly, the contact between the moisture-proof and heat-insulating fabric 200 and the user's body can be reduced, such that the volatilization of sweat can be facilitated and the stickiness of the user's body can be reduced, thereby providing the user with wearing comfort.

It should be understood that the moisture-proof and heat-insulating fabric 200 of the present disclosure can be obtained by disposing the water-repellent ink 230 on the surface of the base cloth 110 of the moisture-sensed deforming fabric 100 facing away from the moisture-sensed shrinking ink 120. Therefore, the configuration of the moisture-sensed shrinking ink 220 of the moisture-proof and heat-insulating fabric 200 is identical to the configuration of the moisture-sensed shrinking ink 120 of the moisture-sensed deforming fabric 100, and will not be repeated hereinafter.

On the other hand, the water-repellent ink 230 is jetted on the second surface 213 of the base cloth 210 to form a water-repellent region B2 on the second surface 213 of the base cloth 210. In some embodiments, a viscosity of the water-repellent ink 230 is between 1.5 cP and 5.0 cP, such that the ink droplets can be jetted with a suitable size, and the water-repellent ink 230 can have suitable fluidity to facilitate the digital printing process. In some embodiments, a surface tension of the water-repellent ink 230 is between 25 dyne/cm and 35 dyne/cm, which facilitates the formation of the ink droplets at the nozzle and provides the water-repellent ink 230 with good permeability. In some embodiments, a particle diameter (D90) of the dispersant in the water-repellent ink 230 may be between 0.001 μm and 1 μm, such that the problem of nozzle clogging during the digital printing process can be avoided, and the water-repellent ink 230 can be provided with good stability. The particle diameter (D90) of the aforementioned dispersant will also affect the viscosity of the water-repellent ink 230. For example, a smaller dispersant particle diameter in water-repellent ink 230 can provide the water-repellent ink 230 with a lower viscosity.

In some embodiments, the water-repellent ink 230 mainly includes 25 parts by weight to 35 parts by weight of the water-repellent agent and 35 parts by weight to 60 parts by weight of water. In some embodiments, the water-repellent agent may include a fluorine resin water-repellent agent, a non-fluorine resin water repellent, or combinations thereof. For example, the water-repellent agent may include a fluorine-based water-repellent agent, a polyurethane water-repellent agent, a silicon-based water-repellent agent, a wax-based water-repellent agent, or combinations thereof. In some embodiments, the water-repellent agent may be, for example, an aqueous fluorine-carbon polymerized water-repellent agent, and a content of the water-repellent agent may be between 29 parts by weight and 30 parts by weight. In some other embodiments, the water-repellent agent may be, for example, an alkyl polyurethane water-repellent agent, and a content of the water-repellent agent may be between 25 parts by weight and 30 parts by weight.

In some embodiments, the water-repellent ink 230 may include 15 parts by weight to 25 parts by weight of a humectant. In some embodiments, the humectant may include glycerin and triethylene glycol, and the ratio in weight of glycerin to triethylene glycol is between 1.8 and 2.2. When the ratio in weight of glycerin to triethylene glycol is within such a range, the water-repellent ink 230 can have better stability and is not easy to become aging.

In some embodiments, the water-repellent ink 230 may include 0.5 parts by weight to 2.0 parts by weight of a surfactant. In some embodiments, the surfactant may include 2,4,7,9-tetramethyl-5-decyne-4,7-diol ethoxy compound, polyether modified organosiloxane, or combinations thereof. The surfactant can ensure the surface tension of the water-repellent ink 230 to be within an appropriate range.

In some embodiments, the water-repellent ink 230 may further include an appropriate amount of a dispersing agent, a PH regulator, and a bacteriostatic agent. The advantages provided by the above-mentioned components can be referred to the above, and will not be repeated hereinafter.

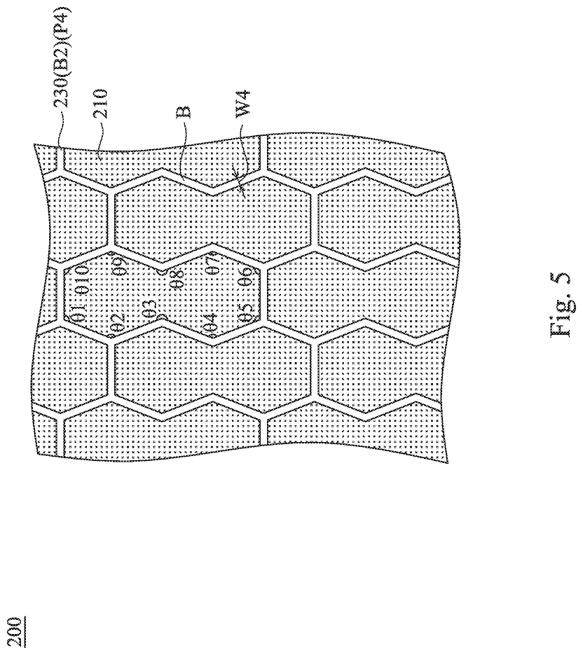

The water-repellent region B2 formed by the water-repellent ink 230 can have various patterns to match with the pattern of the hydrophilic region B1, thereby improving the moisture one-way transport capability and heat-insulating property of the moisture-proof and heat-insulating fabric 200. More specifically, reference is made to FIG. 5, which is a schematic top view illustrating the pattern of the water-repellent region B2 of the moisture-proof and heat-insulating fabric 200 according to some embodiments of the present disclosure.

Reference is made to FIG. 4 and FIG. 5. In some embodiments, the water-repellent region B2 may include a plurality of solid decagonal patterns P4, each solid decagonal pattern P4 has sides formed by a blank region B (i.e., a region other than the water-repellent region B2), and two adjacent solid decagonal patterns P4 share one side or three sides of each of the two adjacent solid decagonal patterns P4. In other words, the blank region B surrounds the solid decagonal patterns P4, so as to form a honeycomb-like pattern on the second surface 213 of the base cloth 210. In some embodiments, a length of each side of the solid decagonal pattern P4 is equal, that is, the solid decagonal pattern P2 is a solid regular decagon, so as to facilitate the sweat to be evenly guided to the first surface 211 of the base cloth 210 along all directions. In some embodiments, the interior angles of each solid decagonal pattern P4 include two reflex angles and eight inferior angles, that is, each solid decagonal pattern P4 includes ten interior angles, and the ten of the interior angles are two reflex angles and eight inferior angles. In detail, each of the interior angles θ3 and θ8 of each solid decagonal pattern P4 is a reflex angle, and each of the interior angles θ1, θ2, θ4-θ7, θ9, and θ10 is an inferior angle. More specifically, the interior angles θ3 and θ8 may respectively be 240 degrees, and the interior angles θ1, θ2, θ4-θ7, θ9, and θ10 may respectively be 120 degrees. From another point of view, each solid decagonal pattern P4 is formed by superimposing one side of each of the two hexagons.

In some embodiments, a line width W4 of the blank region B between two adjacent solid decagonal patterns P4 may be between 1.5 mm and 3.0 mm. In more detail, if the line width W4 of the blank region B is greater than 3.0 mm, the area of the hydrophilic region B1 on the second surface 213 of the base cloth 210 will be too large, which may easily lead to the reversed flow of sweat, thus failing to provide a good heat-insulating property; if the line width W4 of the blank region B is less than 1.5 mm, the sweat cannot be efficiently guided to the first surface 211 of the base cloth 210. As mentioned above, by matching the patterns of the water-repellent region B2 and the patterns of the hydrophilic region B1, the moisture one-way transport capability and the heat-insulating property of the moisture-proof and heat-insulating fabric 200 can be improved. Specifically, a vertical projection of the water-repellent region B2 on the base cloth 210 may partially overlap a vertical projection of the hydrophilic region B1 on the base cloth 210, so as to effectively improve the moisture one-way transport capability and the heat-insulating property of the moisture-proof and heat-insulating fabric 200.

By adjusting the components in the moisture-sensed shrinking ink 220 and the water-repellent ink 230, the moisture-sensed shrinking ink 220 can provide a good moisture-sensed shrinking property, and the water-repellent ink 230 can provide good hydrophobicity. By utilizing the digital printing process to print the moisture-sensed shrinking ink 220 and the water-repellent ink 230 on the two opposite surfaces of the base cloth 210 to form the deformable hydrophilic region B1 and the hydrophobic water-repellent region B2 on the two opposite surfaces of the base cloth 210, the moisture-proof and heat-insulating fabric 200 can provide a good moisture-sensed deforming property, a good moisture one-way transport capability, and a good heat-insulating property after absorbing moisture, thereby providing the user with wearing comfort. In addition, by printing the moisture-sensed shrinking ink 220 and the water-repellent ink 230 on the base cloth 210 through the digital printing process, the fabric can be accurately imparted with partial or overall moisture-sensed shrinking property and hydrophobicity to avoid the excessive use of chemicals, thereby reducing waste and effectively reducing costs. On the other hand, by printing the moisture-sensed shrinking ink 220 and the water-repellent ink 230 on the different surfaces of the base cloth 210, it is possible to avoid the moisture-sensed shrinking ink 220 and the water-repellent ink 230 from interfering with each other and causing their respective performances to be poor.

In the following descriptions, various tests and evaluations will be performed on the moisture-proof and heat-insulating fabrics according to various embodiments of the present disclosure to further verify the efficacy of the present disclosure.

<Experiment 4: Accumulative One-Way Transport Capability Evaluation on Moisture-Proof and Heat-Insulating Fabrics>

In this experiment, the moisture-sensed shrinking ink is jetted on the first surface of the base cloth (a knitted fabric woven from 92% of the polyester (PET) fiber and 8% of the polyurethane (OP) fiber, in which the weight of the base cloth is 180 gsm) by the digital printing process to form the hydrophilic region with the honeycomb-like pattern (as shown in FIG. 2C), and the water-repellent ink is jetted on the second surface of the base cloth by the digital printing process to form the water-repellent region with the honeycomb-like pattern (as shown in FIG. 5), such that the moisture-proof and heat-insulating fabric of Embodiment 42 is obtained. The AATCC195-2011 test method is performed to test the wetting time, the moisture absorption rate, the maximum wetting radius, the spreading speed, the accumulative one-way transport capability, and the overall moisture management capability of the moisture-proof and heat-insulating fabric of Embodiment 42. The test results are shown in Table 4.

TABLE 4

| test items | | test results | |
|---|---|---|---|
| wetting time (s) | second surface | 80 | (level 2) |
| | first surface | 7 | (level 3) |
| moisture absorption | second surface | 7 | (level 1) |
| rate (%/s) | first surface | 60 | (level 4) |
| maximum wetting | second surface | 7 | (level 1) |
| radius (mm) | first surface | 10 | (level 2) |
| spreading speed | second surface | 0.1 | (level 1) |
| (mm/s) | first surface | 0.8 | (level 1) |

| | | |
|---|---|---|
| accumulative one-way transport capability (%) | 946 | (level 5) |
| overall moisture management capability (OMMC) | 0.64 | (level 4) |

It can be seen from Table 4 that the moisture-proof and heat-insulating fabric of the present disclosure indeed provides a good moisture one-way transport capability.

<Experiment 5: Moisture-Sensed Shrinking Property Evaluation on Moisture-Proof and Heat-Insulating Fabric>

In this experiment, the water-repellent ink is jetted on the surface of the moisture-sensed deforming fabrics of the aforementioned Embodiments 1 to 32 by the digital printing process to form the water-repellent region with the honeycomb-like pattern (as shown in FIG. 5), such that the water-repellent region formed by the water-repellent ink and the hydrophilic region formed by the moisture-sensed shrinking ink are respectively disposed on the two opposite surfaces of the base cloth, thereby obtaining the moisture-proof and heat-insulating fabrics of Embodiments 43 to 74. Then, each of the moisture-proof and heat-insulating fabrics is soaked in water, and an average concave/convex depth of each of the moisture-proof and heat-insulating fabrics after deformation is measured and calculated. The detailed information of the moisture-proof and heat-insulating fabrics of Embodiments 43 to 74 and the measurement results are shown in Table 5, in which the concave/convex error before and after disposing the water-repellent region is obtained by the following formula: [(the average concave/convex depth difference before and after disposing the water-repellent region)/(the average concave/convex depth before disposing the water-repellent region)×100%].

TABLE 5

| | having | | average | concave/convex |
|---|---|---|---|---|
| | pattern of | pattern | concave/ | error before and |
| | hydrophilic | of water- | convex | after disposing |
| | region | repellent | depth | the water- |
| | identical to | region | (mm) | repellent region |
| Embodiment 43 | Embodiment 1 | honeycomb- | 1.09 | ≤±1% |
| Embodiment 44 | Embodiment 2 | like pattern | 0.93 | ≤±1% |
| Embodiment 45 | Embodiment 3 | (as shown | 0.74 | ≤±1% |
| Embodiment 46 | Embodiment 4 | in FIG. 5) | 1.32 | ≤±1% |
| Embodiment 47 | Embodiment 5 | | 1.34 | ≤±1% |
| Embodiment 48 | Embodiment 6 | | 1.11 | ≤±1% |
| Embodiment 49 | Embodiment 7 | | 0.95 | ≤±1% |
| Embodiment 50 | Embodiment 8 | | 0.75 | ≤±1% |
| Embodiment 51 | Embodiment 9 | | 0.97 | ≤±1% |
| Embodiment 52 | Embodiment 10 | | 0.84 | ≤±1% |
| Embodiment 53 | Embodiment 11 | | 0.72 | ≤±1% |
| Embodiment 54 | Embodiment 12 | | 1.05 | ≤±1% |
| Embodiment 55 | Embodiment 13 | | 1.04 | ≤±1% |
| Embodiment 56 | Embodiment 14 | | 1.19 | ≤±1% |
| Embodiment 57 | Embodiment 15 | | 1.07 | ≤±1% |
| Embodiment 58 | Embodiment 16 | | 1.33 | ≤±1% |
| Embodiment 59 | Embodiment 17 | | 0.37 | ≤±1% |
| Embodiment 60 | Embodiment 18 | | 0.71 | ≤±1% |
| Embodiment 61 | Embodiment 19 | | 1.09 | ≤±1% |
| Embodiment 62 | Embodiment 20 | | 1.08 | ≤±1% |
| Embodiment 63 | Embodiment 21 | | 0.41 | ≤±1% |
| Embodiment 64 | Embodiment 22 | | 0.39 | ≤±1% |
| Embodiment 65 | Embodiment 23 | | 1.18 | ≤±1% |
| Embodiment 66 | Embodiment 24 | | 3.27 | ≤±1% |
| Embodiment 67 | Embodiment 25 | | 3.70 | ≤±1% |
| Embodiment 68 | Embodiment 26 | | 2.11 | ≤±1% |
| Embodiment 69 | Embodiment 27 | | 2.47 | ≤±1% |
| Embodiment 70 | Embodiment 28 | | 3.84 | ≤±1% |
| Embodiment 71 | Embodiment 29 | | 2.28 | ≤±1% |
| Embodiment 72 | Embodiment 30 | | 2.57 | ≤±1% |
| Embodiment 73 | Embodiment 31 | | 4.29 | ≤±1% |
| Embodiment 74 | Embodiment 32 | | 4.13 | ≤±1% |

The measurement results show that the difference between the average concave/convex depth of each of the moisture-proof and heat-insulating fabrics after moisture absorption and the average concave/convex depth of each of the moisture-sensed deforming fabrics is only less than or equal to ±1%, indicating that the configuration of the water-repellent ink does not affect the moisture-sensed shrinking property provided by the moisture-sensed shrinking ink. Accordingly, the moisture-proof and heat-insulating fabric of each embodiment can have a certain degree of deformation after moisture absorption.

<Experiment 6: Washing Fastness Evaluation on Moisture-Proof and Heat-Insulating Fabric>

In this experiment, some of the moisture-proof and heat-insulating fabrics of Embodiments 43 to 74 are being washed for 20 times, and then the average concave/convex depth of each of the washed moisture-proof and heat-insulating fabrics after moisture-sensing deformation is measured and calculated. The measurement results are shown in Table 6.

TABLE 6

| | the average | the average |
|---|---|---|
| | concave/convex depth | concave/convex depth |
| | before washing (mm) | after washing (mm) |
| Embodiment 45 | 0.74 | 0.72 |
| Embodiment 47 | 1.34 | 1.08 |
| Embodiment 53 | 0.72 | 0.70 |
| Embodiment 58 | 1.34 | 0.79 |
| Embodiment 61 | 1.09 | 0.69 |
| Embodiment 65 | 1.18 | 0.90 |
| Embodiment 73 | 4.29 | 2.18 |

It can be seen from Table 6 that after 20 times for washing of the moisture-proof and heat-insulating fabrics of Embodiments 43 to 74, the average concave/convex depth of each moisture-proof and heat-insulating fabric after moisture absorption can still be between 0.69 mm and 2.18 mm, indicating that there is still a certain degree of deformation after washing, which successfully overcomes the problem of poor washing fastness due to the reagents used in the conventional processing.

<Experiment 7: Moisture-Proof and Heat-Insulating Effect and Drying Time Evaluation on Moisture-Proof and Heat-Insulating Fabric>

In this experiment, the ISO 11092 (Modify) test method was performed to test the moisture-proof and heat-insulating effect and the drying time of the fabric of Comparative Example 2 and some of the moisture-proof and heat-insulating fabrics of Embodiments 43 to 74. It should be noted that the moisture-proof and heat-insulating effect and the drying time are the results obtained by dropping 15 ml of water on an area of 30 cm×30 cm of each moisture-proof and heat-insulating fabric. The test results are shown in Table 7.

TABLE 7

| | thermal resistance | drying |
|---|---|---|
| | (under wet steady-state | time |
| | condition) (° C. · m²/W) | (min) |
| Comparative | −0.033 | 19.67 |
| Example 2 | | |
| Embodiment 45 | −0.032 | 14.67 |
| Embodiment 47 | −0.032 | 14.00 |
| Embodiment 53 | −0.031 | 11.33 |
| Embodiment 58 | −0.031 | 12.33 |
| Embodiment 61 | −0.030 | 10.33 |
| Embodiment 65 | −0.027 | 17.34 |
| Embodiment 73 | −0.026 | 18.67 |

Note:
the moisture-proof and heat-insulating effect gets better as the value of thermal resistance getting closer to 0.

It can be seen from Table 7 that compared with the fabric of Comparative Example 2, the moisture-proof and heat-insulating fabric of each embodiment can provide a better moisture-proof and heat-insulating effect, and the required drying time for the moisture-proof and heat-insulating fabric of each embodiment is significantly shorter, indicating that the moisture-proof and heat-insulating fabric of the present disclosure provides a good heat-insulating property and a good moisture-proof and quick drying property.

According to the aforementioned embodiments of the present disclosure, the moisture-proof and heat-insulating fabric has the hydrophilic region jetted with the moisture-sensed shrinking ink and the water-repellent region jetted with the water-repellent ink. By disposing the water-repellent region and the deformable hydrophilic region on the two opposite surfaces of the base cloth, the moisture-proof and heat-insulating fabric can partially deform after absorbing moisture and provide a good moisture one-way transport capability, so as to facilitate the volatilization of sweat, reduce the stickiness of the user's body, and provide a good heat-insulating property, thereby providing the user with wearing comfort. In addition, by disposing the water-repellent region and the hydrophilic region on the two opposite surfaces of the base cloth, and through the respective designs of the patterns of the hydrophilic region and the water-repellent region, the moisture one-way transport capability and the heat-insulating property can be effectively improved.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure covers modifications and variations of this disclosure provided they fall within the scope of the following claims.

What is claimed is:

1. A moisture-sensed deforming fabric, comprising:
a base cloth; and
a moisture-sensed shrinking ink jetted on one of surfaces of the base cloth by a digital printing process, wherein the moisture-sensed shrinking ink forms a hydrophilic region on the surface of the base cloth.

2. The moisture-sensed deforming fabric of claim 1, wherein a viscosity of the moisture-sensed shrinking ink is between 2.5 cP and 10.0 cP, a surface tension of the moisture-sensed shrinking ink is between 22 dyne/cm and 32 dyne/cm, and the moisture-sensed shrinking ink comprises 15 parts by weight to 35 parts by weight of a moisture-sensed shrinking resin and 65 parts by weight to 85 parts by weight of water.

3. The moisture-sensed deforming fabric of claim 2, wherein the moisture-sensed shrinking resin is manufactured by the following reagents comprising:
a polyol;
a polyamine;
a first cross-linking agent comprising an isocyanate block; and
a second cross-linking agent comprising an isocyanate block.

4. The moisture-sensed deforming fabric of claim 1, wherein the hydrophilic region comprises a plurality of hollow circular patterns, and the hollow circular patterns are arranged at intervals.

5. The moisture-sensed deforming fabric of claim 4, wherein the hollow circular patterns are arranged in an array.

6. The moisture-sensed deforming fabric of claim 4, wherein the hollow circular patterns are arranged along a first direction and a second direction, and an angle between the first direction and the second direction is between 40 degrees and 50 degrees.

7. The moisture-sensed deforming fabric of claim 1, wherein the hydrophilic region comprises a plurality of hollow hexagonal patterns, and two of the adjacent hollow hexagonal patterns share one side of each of the two adjacent hollow hexagonal patterns.

8. The moisture-sensed deforming fabric of claim 7, wherein each of the hollow hexagon patterns is a regular hexagonal pattern.

9. The moisture-sensed deforming fabric of claim 1, wherein the hydrophilic region comprises a plurality of strip-shaped patterns, and the strip-shaped patterns are arranged in parallel.

10. The moisture-sensed deforming fabric of claim 9, wherein the strip-shaped patterns are arranged equidistantly.

11. A moisture-proof and heat-insulating fabric, comprising:
a base cloth having a first surface and a second surface facing away from the first surface;
a moisture-sensed shrinking ink jetted on the first surface of the base cloth by a digital printing process, wherein the moisture-sensed shrinking ink forms a hydrophilic region on the first surface; and
a water-repellent ink jetted on the second surface of the base cloth by the digital printing process, wherein the water-repellent ink forms a water-repellent region on the second surface.

12. The moisture-proof and heat-insulating fabric of claim 11, wherein a viscosity of the moisture-sensed shrinking ink is between 2.5 cP and 10.0 cP, a surface tension of the moisture-sensed shrinking ink is between 22 dyne/cm and 32 dyne/cm, and the moisture-sensed shrinking ink comprises 15 parts by weight to 35 parts by weight of a moisture-sensed shrinking resin and 65 parts by weight to 85 parts by weight of water.

13. The moisture-proof and heat-insulating fabric of claim 12, wherein the moisture-sensed shrinking resin is manufactured by the following reagents comprising:
a polyol;
a polyamine;
a first cross-linking agent comprising an isocyanate block; and
a second cross-linking agent comprising an isocyanate block.

14. The moisture-proof and heat-insulating fabric of claim 11, wherein the first surface of the base cloth is configured to be in contact with an external environment, and the second surface of the base cloth is configured to be in contact with a body of a user.

15. The moisture-proof and heat-insulating fabric of claim 11, wherein the hydrophilic region comprises a plurality of hollow circular patterns, and the hollow circular patterns are arranged at intervals.

16. The moisture-proof and heat-insulating fabric of claim 15, wherein the hollow circular patterns are arranged along a first direction and a second direction, and an angle between the first direction and the second direction is between 40 degrees and 50 degrees.

17. The moisture-proof and heat-insulating fabric of claim 11, wherein the hydrophilic region comprises a plurality of hollow hexagonal patterns, and two adjacent hollow hexagonal patterns of the hollow hexagonal patterns share one side of each of the two adjacent hollow hexagonal patterns.

18. The moisture-proof and heat-insulating fabric of claim 11, wherein the hydrophilic region comprises a plurality of strip-shaped patterns, and the strip-shaped patterns are arranged in parallel.

19. The moisture-proof and heat-insulating fabric of claim 11, wherein the water-repellent region comprises a plurality of solid decagonal patterns, and two adjacent solid decagonal patterns of the solid decagonal patterns share one side or three sides of each of the two adjacent solid decagonal patterns.

20. The moisture-proof and heat-insulating fabric of claim 11, wherein a vertical projection of the hydrophilic region on the base cloth partially overlaps a vertical projection of the water-repellent region on the base cloth.
